(19) United States
(12) Patent Application Publication
(10) Pub. No.: US 2018/0163944 A1
(43) Pub. Date: Jun. 14, 2018

(54) AIR PERMEABLE CAP

(71) Applicant: KOMEMTEC Co., Ltd., Jeollanam-do (KR)

(72) Inventors: Sung Chul KIM, Seoul (KR); Dae Yeul CHUN, Gyeonggi-do (KR); Jang Il PARK, Incheon (KR); Kook Jin CHO, Seoul (KR)

(73) Assignee: KOMEMTEC Co., Ltd., Jeollanam-do (KR)

(21) Appl. No.: 15/815,773

(22) Filed: Nov. 17, 2017

(30) Foreign Application Priority Data
Dec. 14, 2016 (KR) 10-2016-0170482

(51) Int. Cl. F21S 8/10; F21V 31/03

(52) U.S. Cl. CPC F21S 48/335; B60Q 1/0408; F21V 31/03; F21S 48/337

(57) ABSTRACT

Disclosed is an air permeable cap, which includes a body connected to an opening of a lamp housing for a vehicle, the body having an inner space formed therein to communicate with the lamp housing and having an air permeating hole formed at one end thereof to communicate with the inner space; a cover member having an insert space formed therein so that one end of the body is inserted therein; and a plurality of support protrusions configured to protrude from an inner side of the cover member toward a center of the insert space to support the body to be spaced from the inner side of the cover member so that an air permeating channel for allowing air flow is formed between the inner side of the cover member and the body.

### TECHNICAL FIELD

The present disclosure relates to an air permeable cap, and more particularly, to an air permeable cap installed at a vehicle lamp housing to give dustproof and waterproof functions when the housing is ventilated.

### BACKGROUND ART

Conventionally, an air permeable cap is used at a housing of a device such as vehicle electric components like vehicle headlights, taillights, fog lamps, direction indicators, motors, various pressure sensors, pressure switches and electronic control unit (ECU) cases as well as portable telephones, cameras, electric shavers, electric toothbrushes and outdoor lamps.

In other words, the device housing has an air permeable cap provided at an opening formed to communicate between the inside and the outside of the device. The air permeable cap prevents water, dust or the like from flowing into the inside of the device, and mitigates the change of pressure inside the device housing caused by the temperature change, transmits sound between the inside and the outside of the device housing, and also emits the gas generated in the device housing.

The housing of a device such as a vehicle electric component exposed to contaminants such as rainwater, mud, water and oil may have an L-shaped cylindrical body or a U-shaped cylindrical body, or may have an air permeable cap having a maze structure therein. The air permeable cap is coupled to a mounting opening formed at the neck of the housing for the mounting of the air permeable cap.

The L-shaped or U-shaped body has a relatively simple structure, but the efficiency of blocking contaminants is not high. Also, the body having a maze structure is relatively complicated, which may increase the cost and manpower in fabricating the body.

### RELATED LITERATURE

### Patent Literature

Korean Utility Registration No. 20-0152751 (Apr. 30, 1999)

### DISCLOSURE

### Technical Problem

The present disclosure is designed to solve the problems of the related art, and therefore the present disclosure is directed to providing an air permeable cap, which is composed of a body and a cover to have a relatively simple structure and ensures excellent contamination blocking efficiency.

### Technical Solution

In one aspect of the present disclosure, there is provided an air permeable cap, comprising: a body connected to an opening of a lamp housing for a vehicle, the body having an inner space formed therein to communicate with the lamp housing and having an air permeating hole formed at one end thereof to communicate with the inner space; a cover member having an insert space formed therein so that one end of the body is inserted therein; and a plurality of support protrusions configured to protrude from an inner side of the cover member toward a center of the insert space to support the body to be spaced from the inner side of the cover member so that an air permeating channel for allowing air flow is formed between the inner side of the cover member and the body.

The cover member may have a plurality of air exhaust holes formed in a side thereof, which is opposite to the air permeating hole, so that an inner air of the insert space is exhausted out.

The body may have insert grooves formed in an outer circumference thereof, which is opposite to the support protrusions, so that the support protrusions are inserted therein.

The insert grooves may be formed inwards with respect to the outer circumference of the body into a predetermined depth and extend from one end of the body to the other end thereof, and both ends of the insert grooves may be respectively opened so that the support protrusions are inserted therein in an easy way.

The support protrusions may extend by a predetermined length along the extending direction of the insert grooves.

The support protrusions may extend so that both ends thereof are adjacent to an edge of an inlet of the insert space into which the body is inserted and an inner side of the cover member which is opposite to the air permeating hole of the body, respectively.

Meanwhile, the air permeable cap according to the present disclosure may further comprise a plurality of holding protrusions formed at the inner side of the cover member, which is opposite to the air permeating hole of the body, to protrude toward the body so that one end of the body is supported to be spaced by a predetermined distance from the inner side of the cover member, which is opposite to the air permeating hole of the body.

The insert groove may be formed in the body at a location spaced from one end of the body toward the other end thereof by a distance shorter than the spacing distance between the support protrusions and the inner side of the cover member, which is opposite to the air permeating hole of the body, so that the body is supported to be spaced by a predetermined distance from the inner side of the cover member, which is opposite to the air permeating hole of the body.

### Advantageous Effects

The air permeable cap according to the present disclosure includes a body installed at an opening of a lamp housing, a cover member installed to surround the body, and a support protrusion for separating of the body from an inside of the cover member so that a channel for air flowing into and out of the lamp housing is bent, and thus the air permeable cap may ensure excellent contamination blocking efficiency and reduce cost and manpower for its fabrication due to a relatively simple structure.

### DESCRIPTION OF DRAWINGS

FIG. 1 is an exploded perspective view showing an air permeable cap according to the present disclosure.

FIG. 2 is a perspective view showing a bottom of the air permeable cap of FIG. 1.

FIG. 3 is a cross-sectioned view showing the air permeable cap of FIG. 1.

FIG. 4 is a cross-sectioned view showing an air permeable cap according to another embodiment of the present disclosure.

### BEST MODE

Hereinafter, an air permeable cap according to an embodiment of the present disclosure will be described in detail with reference to the accompanying drawings. The present disclosure can be changed and modified in various ways, and so specific embodiments will be depicted in the drawings and described in detail in the specification. However, this is not to limit the present disclosure to specific embodiments, but the present disclosure should be interpreted as including all changes, equivalents and substitutions which fall within the scope of the present disclosure. When explaining the drawings, like elements are designated by like reference signs. In the accompanying drawings, the dimensions of components may be exaggerated for better understanding of the present disclosure.

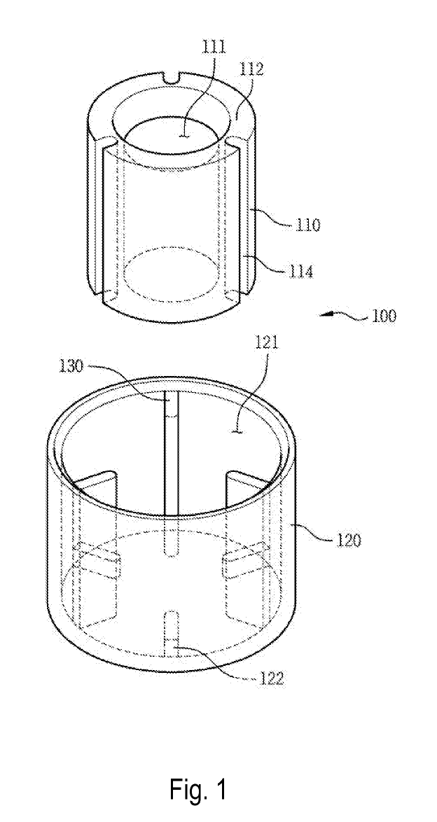

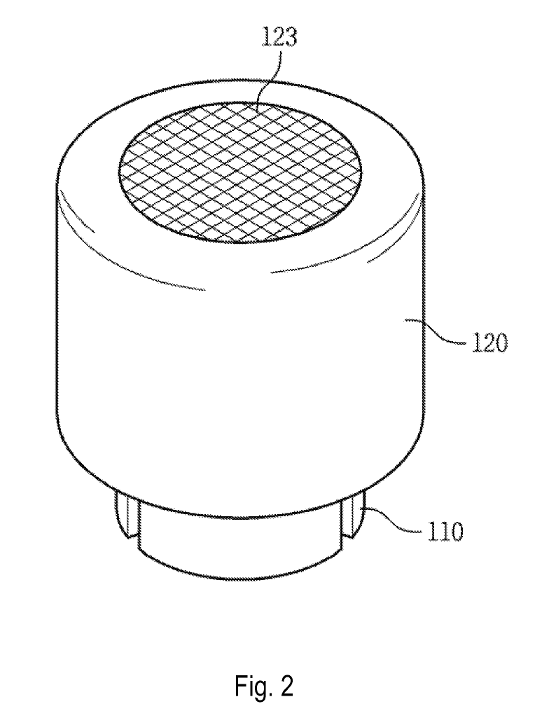

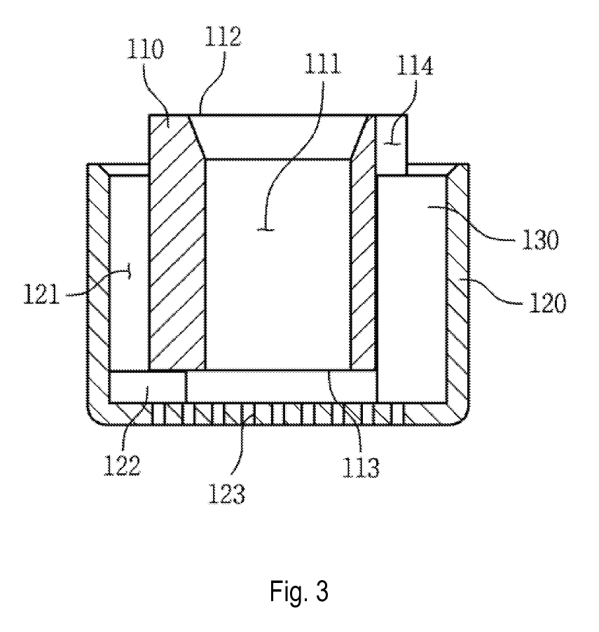

FIGS. 1 to 3 show an air permeable cap 100 according to the present disclosure.

Referring to FIGS. 1 to 3, the air permeable cap 100 includes a body 110 connected to an opening of a lamp housing for a vehicle, a cover member 120 having an insert space 121 so that one end of the body 110 is inserted therein, and support protrusions 130 formed an inner side of the cover member 120 to support the body 110 to be spaced from the inner side of the cover member 120.

At this time, the lamp housing for a vehicle has an installation space formed therein so that a lamp unit for emitting light is installed therein, and an opening is formed at one side thereof to protrude outward. Also, an exhaust hole communicating with the installation to exhaust an inner gas of the lamp housing for a vehicle to the outside is formed at an end of the opening. The lamp housing for a vehicle is a housing having a lamp unit therein, which is a lamp case generally used in the existing technique, and is not described in detail here.

The body 110 has an inner space 111 formed therein to communicate with the lamp housing and is formed in a cylindrical shape extending by a predetermined length. At this time, the body 110 may be formed to have an outer diameter smaller than an inner diameter of the cover member 120.

An air permeating hole 113 communicating with the inner space 111 is formed at one end of the body 110, and an insert hole 112 is formed at the other end of the body 110 so that the opening of the lamp housing may be inserted into the inner space 111. At this time, the insert hole 112 may be formed to be tapered so that an edge of the insert hole 112 has an expanding diameter and thus the opening of the lamp housing may be easily inserted therein.

In addition, insert grooves 114 are respectively formed at an outer circumference of the body 110, which is opposite to the support protrusions 130, so that the end of the support protrusions 130 may be inserted therein. A plurality of insert grooves 114 may be formed at an outer circumference of the body 110 to be spaced from each other along the circumferential direction. At this time, the insert groove 114 is inserted in a predetermined depth inwards with respect to the outer circumference of the body 110 so that the support protrusion 130 may be partially inserted therein, and extends from one end of the body 110 to the other end thereof. Also, both end surfaces of the insert groove 114 may be formed to be opened so that the support protrusion 130 may to be easily inserted therein.

The cover member 120 is formed in a cylindrical shape having an insert space 121 therein. One side of the cover member 120 is closed and the other side is opened so that one end of the body 110 is inserted into the insert space 121, thereby serving as an inlet of the insert space 121.

The cover member 120 may be formed to have an inner diameter larger than an outer diameter of the body 110 so that an air permeating channel through which air flows is formed between the inner side and the outer circumference of the body 110. In addition, the cover member 120 is tapered so that an edge near the inlet of the insert space 121 has an expanding inner diameter and thus one end of the body 110 may be easily inserted therein.

In addition, the cover member 120 has a plurality of air exhaust holes 123 formed in an inner surface at the other side, which is opposite to the air permeating hole 113 of the body 110, so that the inner air of the insert space 121 may be exhausted to the outside. At this time, though not shown in the drawing, the other side of the cover member 120 is provided to cover the air exhaust hole 123, and a filter for filtering contaminants may be installed may be installed at the other side of the cover member 120 to prevent the contaminants from flowing into the cover member 120 through the air exhaust hole 123.

Moreover, the cover member 120 may include a plurality of holding protrusions 122 formed on the inner wall of the cover member 120 at the other side to protrude toward the body 110, so that the plurality of holding protrusions 122 support one end of the body 110 to be spaced by a predetermined distance from the inner wall of the cover member 120 at the other side, which is opposite to the air permeating hole 113 of the body 110. The holding protrusions 122 may extend from the inner circumferential of the cover member 120 toward a center of the insert space 121 and may be formed in the intervals of the support protrusions 130, respectively.

The body 110 inserted into the insert space 121 by the holding protrusion 122 is prevented from closely adhering to the inner wall of the cover member 120 at the other side, so that an air permeating channel is formed between one end of the body 110 and the inner wall of the cover member 120 at the other side.

The support protrusions 130 are formed to protrude from the inner circumference of the cover member 120 toward the center of the insert space 121 to support the body 110 to be spaced from the inner side of the cover member 120 such that an air permeating channel through which air flows is formed between the inner circumference of the cover member 120 and the body 110. At this time, the support protrusions 130 are spaced from each other in the circumferential direction on the inner circumference of the cover member 120 and may be arranged radially with respect to the center of the insert space 121.

In addition, the support protrusion 130 also extends in parallel with the extending direction of the insert groove 114 of the body 110, and the support protrusion 130 may extend so that both ends thereof are adjacent to an edge of an inlet of the insert space 121 into which the body 110 is inserted and the inner wall of the cover member 120 which is opposite to the air permeating hole 113 of the body 110, respectively, in order to allow the support protrusion 130 to be easily inserted into the insert groove 114.

The support protrusions 130 and the holding protrusions 122 configured as above support the body 110 inserted into the insert space 121 to be spaced from the inner circumference of the cover member 120 and the inner wall thereof at the other side, so that the air permeating channel through which air flows is formed between the body 110 and the cover member 120. Here, the air permeating channel is bent by the body 110 and the cover member 120 to prevent contaminants from entering the lamp housing through the air permeating hole 113. Also, the air permeable cap 100 according to the present disclosure has a relatively simple structure, and thus it is possible to reduce the cost and manpower required for fabrication.

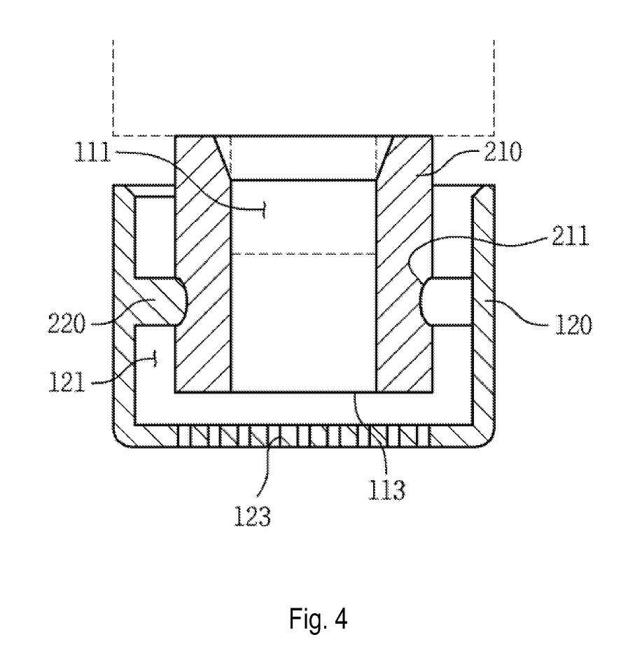

Meanwhile, FIG. 4 shows a body 210 according to another embodiment of the present disclosure. The same reference numerals denote the same elements as in the former drawings.

Referring to FIG. 4, in the body 210, an insert groove 211 is formed on the outer circumference thereof at a position spaced by a predetermined distance from one end of the body 210 to the other end thereof, instead of the holding protrusion 122. At this time, a support protrusion 220 is not adjacent to the inner wall of the cover member 120 at the other side but is spaced apart from the inner wall of the cover member 120 at the other side by a predetermined distance.

Meanwhile, the insert groove 211 may be formed in the body 210 at a location spaced from one end of the body 210 toward the other end thereof by a distance shorter than the spacing distance between the support protrusion 220 and the inner wall of the cover member 120 at the other side, which is opposite to the air permeating hole 113 of the body 210, so that one end of the body 210 may be spaced from the inner wall surface of the cover member 120 at the other side.

In the body 210 configured as above, since one end of the body 210 is spaced from the inner wall of the cover member 120 at the other side without using the holding protrusion 122, the structure becomes simpler and the manufacturing cost may be reduced.

The proposed embodiments are described to enable any person skilled in the art to make or use the present disclosure. Various modifications of these embodiments will be readily apparent to those of ordinary skill in the art, and the generic principles defined herein may be applied to other embodiments without departing from the scope of the present disclosure. Thus, the present disclosure is not to be limited to the embodiments proposed herein but should be interpreted based on the widest scope consistent with the principles and novel features presented herein.

### REFERENCE SIGNS

100: air permeable cap

110: body

111: inner space

112: insert hole

113: air permeating hole

114: insert groove

120: cover member

121: insert space

122: holding protrusion

123: air exhaust hole

130: support protrusion

What is claimed is:

1. An air permeable cap, comprising:
a body connected to an opening of a lamp housing for a vehicle, the body having an inner space formed therein to communicate with the lamp housing and having an air permeating hole formed at one end thereof to communicate with the inner space;
a cover member having an insert space formed therein so that one end of the body is inserted therein; and
a plurality of support protrusions configured to protrude from an inner side of the cover member toward a center of the insert space to support the body to be spaced from the inner side of the cover member so that an air permeating channel for allowing air flow is formed between the inner side of the cover member and the body.

2. The air permeable cap according to claim 1,
wherein the cover member has a plurality of air exhaust holes formed in a side thereof, which is opposite to the air permeating hole, so that an inner air of the insert space is exhausted out.

3. The air permeable cap according to claim 1,
wherein the body has insert grooves formed in an outer circumference thereof, which is opposite to the support protrusions, so that the support protrusions are inserted therein.

4. The air permeable cap according to claim 3,
wherein the insert grooves are formed inwards with respect to the outer circumference of the body into a predetermined depth and extend from one end of the body to the other end thereof, and both ends of the insert grooves are respectively opened so that the support protrusions are inserted therein in an easy way.

5. The air permeable cap according to claim 4,
wherein the support protrusions extend by a predetermined length along the extending direction of the insert grooves.

6. The air permeable cap according to claim 5,
wherein the support protrusions extend so that both ends thereof are adjacent to an edge of an inlet of the insert space into which the body is inserted and an inner side of the cover member which is opposite to the air permeating hole of the body, respectively.

7. The air permeable cap according to claim 1, further comprising:
a plurality of holding protrusions formed at the inner side of the cover member, which is opposite to the air permeating hole of the body, to protrude toward the body so that one end of the body is supported to be spaced by a predetermined distance from the inner side of the cover member, which is opposite to the air permeating hole of the body.

8. The air permeable cap according to claim 3,
wherein the insert grooves are formed in the body at a location spaced from one end of the body toward the other end thereof by a distance shorter than the spacing distance between the support protrusions and the inner side of the cover member, which is opposite to the air permeating hole of the body, so that the body is supported to be spaced by a predetermined distance from the inner side of the cover member, which is opposite to the air permeating hole of the body.
